(19) United States
(12) Patent Application Publication
(10) Pub. No.: US 2024/0326745 A1
(43) Pub. Date: Oct. 3, 2024

(54) MOBILE OBJECT SETTING SYSTEM AND MOBILE OBJECT SETTING METHOD

(71) Applicant: HONDA MOTOR CO., LTD., Tokyo (JP)

(72) Inventors: Yoshihiro Matsugi, Tokyo (JP); Naoki Shibata, Tokyo (JP); Koji Hashimoto, Tokyo (JP); Shogo Usui, Tokyo (JP); Shohei Kamochi, Tokyo (JP); Takaya Higuchi, Tokyo (JP); Tomohiro Suzuki, Tokyo (JP)

(21) Appl. No.: 18/585,119

(22) Filed: Feb. 23, 2024

(30) Foreign Application Priority Data
Mar. 29, 2023 (JP) 2023-052646

(51) Int. Cl. B60R 25/30

(52) U.S. Cl. CPC B60R 25/307

(57) ABSTRACT

A mobile object setting system includes a setting device configured to perform a process of setting equipment provided in a mobile object and a plurality of terminal devices capable of communicating with the setting device. The setting device includes a storage device configured to store a program and setting information of the equipment and a hardware processor. The hardware processor manages the setting information in association with a user of the mobile object by executing the program stored in the storage device, identifies the user of the mobile object, detects a specific action to be performed when the user of the mobile object boards the mobile object, and acquires setting information of the equipment associated with the identified user from the storage device to set the equipment based on the acquired setting information. The hardware processor receives a selection manipulation of the user until a predetermined manipulation is performed after the specific action is detected.

### CROSS-REFERENCE TO RELATED APPLICATION

Priority is claimed on Japanese Patent Application No. 2023-052646, filed Mar. 29, 2023, the content of which is incorporated herein by reference.

### BACKGROUND

### Field of the Invention

The present invention relates to a mobile object setting system and a mobile object setting method.

### Description of Related Art

Conventionally, a so-called smart entry function in which a vehicle door can be locked and unlocked without taking out a portable device such as an electronic key by performing a comparison process for a key ID (portable device unique information), which is unique information for each portable device, is known. In relation to the smart entry function, technology for transmitting personal information stored in a user's electronic key to a vehicle-side device through wireless communication, reading setting information associated with the personal information received by the vehicle-side device, and automatically adjusting a vehicle environment (a seat position or the like) based on the setting information has been proposed (Japanese Unexamined Patent Application, First Publication No. 2010-214972). In some conventional smart entry functions, different setting information can be associated with a plurality of electronic keys. In recent years, as technology for automatically adjusting the vehicle environment, technology for performing user management with an in-vehicle device connected to a vehicle electronic control unit (ECU) and automatically adjusting the vehicle environment based on setting information of a logged-in user has also been developed. In this case, the user can flexibly change the setting content of the vehicle environment by changing the logged-in user, so that the convenience of the vehicle is improved.

### SUMMARY

However, it is not always necessary to set the vehicle environment in detail depending on the user and the user may desire to start the use of the vehicle only by manipulating an electronic key without manipulating the in-vehicle device. Therefore, it is desirable to improve the convenience of the vehicle by more appropriately linking the in-vehicle device and the electronic key.

The present invention has been made in consideration of such circumstances and an objective of the present invention is to provide a mobile object setting system and a mobile object setting method capable of more appropriately linking an in-vehicle device and an electronic key to improve the convenience of a vehicle in relation to a vehicle control system that automatically adjusts a vehicle environment in conjunction with an in-vehicle device having a user management function. In the end, it will further improve traffic safety and contribute to the development of a sustainable transportation system.
(1): According to an aspect of the present invention, there is provided a mobile object setting system including a setting device configured to perform a process of setting equipment provided in a mobile object and a plurality of terminal devices capable of communicating with the setting device, wherein the setting device includes a storage device configured to store a program and setting information of the equipment and a hardware processor, wherein the hardware processor manages the setting information in association with a user of the mobile object by executing the program stored in the storage device, identifies the user of the mobile object, detects a specific action to be performed when the user of the mobile object boards the mobile object, and acquires setting information of the equipment associated with the identified user from the storage device to set the equipment based on the acquired setting information, and wherein the hardware processor receives a selection manipulation of the user until a predetermined manipulation is performed after the specific action is detected.
(2): In the above-described aspect (1), the predetermined manipulation is a manipulation of starting up the mobile object.
(3): In the above-described aspect (2), the hardware processor determines the user when the prescribed manipulation has been performed and sets the equipment based on setting information associated with the determined user.
(4): In the above-described aspect (1), the hardware processor identifies the user of the mobile object based on user information received from a terminal device of the user and overwrites the user information of the user before a change stored in the terminal device with the user information of the user after the change when the selection manipulation of the user has been received.
(5): In the above-described aspect (1), the hardware processor sets a position of a seat of the mobile object based on setting information of the user until the predetermined manipulation is performed after the specific action is detected and sets the equipment other than the seat after the predetermined manipulation is performed.
(6): In the above-described aspect (1), the hardware processor sets a position of a seat of the mobile object based on setting information received from the terminal device when the selection manipulation of the user has not been performed.
(7): In the above-described aspect (6), the storage device stores setting information of a previous user of the mobile object, and the hardware processor sets the equipment other than the seat based on the setting information of the previous user when the selection manipulation of the user has not been performed.
(8): In the above-described aspect (1), the hardware processor identifies a user of the mobile object using a display device including a display configured to display a list of users registered in the setting device and an inputter configured to receive a manipulation of selecting a user among the users displayed on the display.
(9): In the above-described aspect (1), the display device includes a sound output device configured to output a sound for prompting the user to perform the selection manipulation.
(10): According to an aspect of the present invention, there is provided a mobile object setting system including a setting device configured to perform a process of setting equipment provided in a mobile object and a plurality of terminal devices capable of communicating with the setting device, wherein the setting device includes a storage device configured to store a program and setting information of the equipment and a hardware processor, wherein the hardware processor manages the setting information in association with a user of the mobile object by executing the program stored in the storage device, identifies the user of the mobile object, detects a specific action to be performed when the user of the mobile object boards the mobile object, and acquires setting information of the equipment associated with the identified user from the storage device to set the equipment based on the acquired setting information, and wherein the terminal device stores setting information corresponding to any one of users of the mobile object and overwrites the setting information stored in advance with setting information of the identified user when the hardware processor identifies the user of the mobile object.
(11): According to an aspect of the present invention, there is provided a mobile object setting method for use in a mobile object setting system including a setting device configured to perform a process of setting equipment provided in a mobile object and a plurality of terminal devices capable of communicating with the setting device, the mobile object setting method including: managing, by the setting device, the setting information of the equipment in association with a user of the mobile object; identifying, by the setting device, the user of the mobile object; detecting, by the setting device, a specific action to be performed when the user of the mobile object boards the mobile object; acquiring, by the setting device, setting information of the equipment associated with the identified user to set the equipment based on the acquired setting information; and receiving, by the setting device, a selection manipulation of the user until a predetermined manipulation is performed after the specific action is detected.
(12): According to an aspect of the present invention, there is provided a mobile object setting method for use in a mobile object setting system including a setting device configured to perform a process of setting equipment provided in a mobile object and a plurality of terminal devices capable of communicating with the setting device, the mobile object setting method including: managing, by the setting device, the setting information of the equipment in association with a user of the mobile object; identifying, by the setting device, the user of the mobile object; detecting, by the setting device, a specific action to be performed when the user of the mobile object boards the mobile object; acquiring, by the setting device, setting information of the equipment associated with the identified user to set the equipment based on the acquired setting information; and storing, by the terminal device, setting information corresponding to any one of users of the mobile object and overwriting the setting information stored in advance with setting information of the identified user when the hardware processor identifies the user of the mobile object.

According to (1) to (12), it is possible to more appropriately link an in-vehicle device and an electronic key to improve the convenience of a vehicle in relation to a vehicle control system that automatically adjusts a vehicle environment in conjunction with an in-vehicle device having a user management function.

### BRIEF DESCRIPTION OF THE DRAWINGS

FIG. 1 is a diagram showing an example of a configuration of a vehicle control system 1 of an embodiment.

FIG. 2 is a figure showing an example of content of account management information 92.

FIG. 3 is a flowchart showing a flow of a process executed by a controller 70.

FIG. 4 is a diagram (Part 1) showing an example of an operation of the vehicle control system 1 of the embodiment.

FIG. 5 is a diagram (Part 2) showing an example of an operation of the vehicle control system 1 of the embodiment.

### DESCRIPTION OF EMBODIMENTS

Hereinafter, embodiments of a mobile object setting system and a mobile object setting method of the present invention will be described with reference to the drawings.

### [1. Overall Configuration of Vehicle Control System]

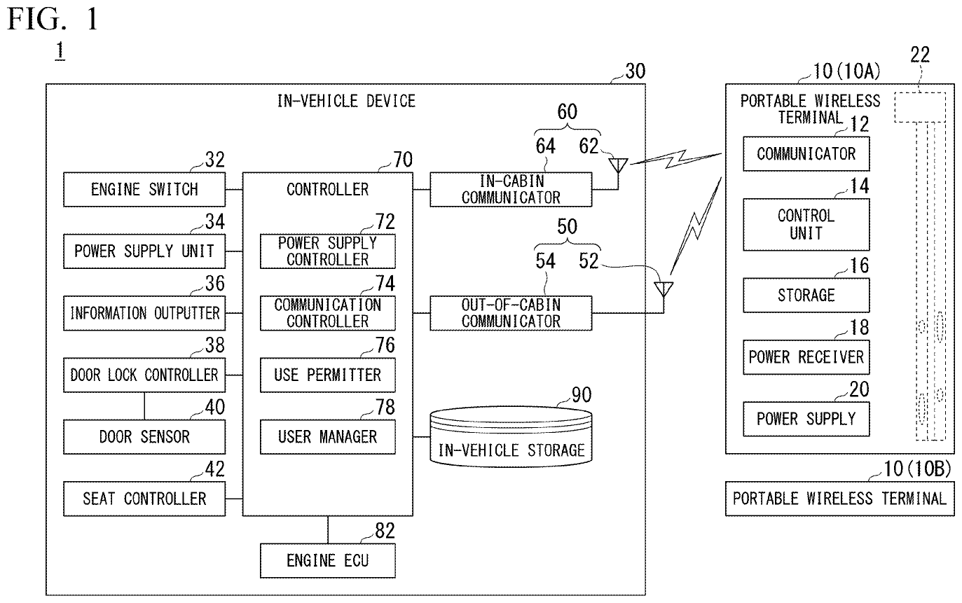

FIG. 1 is a diagram showing an example of a configuration of a vehicle control system 1 of an embodiment. The vehicle control system 1 includes a plurality of portable wireless terminals 10 and an in-vehicle device 30 mounted in a control target vehicle (hereinafter referred to as a “host vehicle”). The portable wireless terminal 10 is an example of an “electronic key” for a vehicle. The portable wireless terminal 10 and the in-vehicle device 30 can communicate with each other through wireless communication and the in-vehicle device 30 causes the host vehicle to perform a predetermined operation using communication with the portable wireless terminal 10 as a trigger. With such a mechanism, the user can use the portable wireless terminal 10 to cause the host vehicle to perform an operation such as unlocking a door lock or starting an engine. The vehicle control system 1 is an example of a “mobile object setting system” and the in-vehicle device 30 is an example of a “setting device.” The host vehicle is an example of a mobile object and a setting target in the mobile object setting system may be a mobile object other than a car, such as a watercraft or an aircraft.

Portable wireless terminals 10A and 10B are examples of a plurality of portable wireless terminals 10 and have similar functional configurations. Here, two portable wireless terminals 10 are exemplified in consideration of a main key and a spare key, but the number of portable wireless terminals 10 may be one or three or more. Hereinafter, unless otherwise distinguished, the portable wireless terminals 10A and 10B are collectively referred to as a portable wireless terminal 10. Hereinafter, when it is necessary to distinguish the portable wireless terminals 10A and 10B in the description with respect to a functional configuration similar to that described above, “A” or “B” may be added to the reference sign of each functional unit to distinguish them. For example, it is assumed that a “communicator 12A” is a communicator 12 of the portable wireless terminal 10A. The portable wireless terminal 10 is an example of a “terminal device.”

### [2. Configuration of Portable Wireless Terminal]

The portable wireless terminal 10 is, for example, a so-called FOB key (key fob), a thin card key, or the like. These portable wireless terminals 10, for example, have sizes with which they can be accommodated in a wallet. The portable wireless terminal 10, for example, has a size of about several centimeters (cm) to 10 cm in length, several centimeters (cm) to 10 cm in width, and several millimeters (mm) to several centimeters (cm) in thickness. In the following embodiment, an example in which the portable wireless terminal 10 is a FOB key will be described, but it may be another electronic key. The portable wireless terminal 10 may have the above-described function by installing an application program in a portable phone such as a smartphone, a tablet terminal, or the like.

In the portable wireless terminal 10, for example, a communicator 12, a control unit 14 including an integrated circuit and the like, a storage 16, a power receiver 18, a power supply 20, and a mechanical key 22 are housed in a housing (not shown). For example, the communicator 12 performs a predetermined process such as amplification or demodulation for received radio waves or generates radio waves to be transmitted. The storage 16 stores vehicle environment setting information in advance by associating the identification information (a user ID to be described below) of any one of the users of the vehicle with the identification information.

The control unit 14 normally controls the portable wireless terminal 10 in a sleep state, which is a power-saving state. When a request signal is received from the in-vehicle device 30, the control unit 14 controls the portable wireless terminal 10 so that the portable wireless terminal 10 transitions from the sleep state to a startup state. The control unit 14 causes the communicator 12 to transmit a (out-of-cabin or in-cabin) response signal that is a response signal corresponding to the reception of a (out-of-cabin or in-cabin) request signal transmitted from the in-vehicle device 30.

The power supply 20 is, for example, a button battery. The portable wireless terminal 10 operates with electric power supplied from the power supply 20. When an amount of electric power stored in the power supply 20 (a residual power amount) is insufficient, the portable wireless terminal 10 does not operate. In this case, the user needs to replace, for example, the button battery. The power supply 20 may be, for example, a battery capable of being charged with electric power supplied through a Universal Serial Bus (USB).

The mechanical key 22 is a key for mechanically unlocking or locking a lock of a door (a door lock). When the user inserts the mechanical key 22 into a keyhole of the door of the host vehicle and performs a predetermined operation, the door lock of the host vehicle transitions to an unlocked or locked state.

### [3. Configuration of In-Vehicle Device]

The in-vehicle device 30 is mounted in the host vehicle. The in-vehicle device can control each part of the host vehicle so that each part of the host vehicle can perform a predetermined operation. The predetermined operation is an operation for adjusting a vehicle environment of the host vehicle to a mode according to the user. In the present embodiment, it is assumed that the in-vehicle device 30 is able to adjust the seat position and at least one or more of the vehicle environments other than the seat position. Hereinafter, the seat position is positioned as the first vehicle environment and at least one or more of the vehicle environments other than the seat position may be collectively referred to as a “second vehicle environment” when it is not necessary to distinguish otherwise. In the present embodiment, the second vehicle environment is not limited to a specific one.

For example, the second vehicle environment may be other than the seat position among states of various types of in-vehicle equipment. For example, the second vehicle environment may be the angle of the fender mirror, the inclination of the seat, the position or angle of the steering wheel, or the like. The second vehicle environment may be an operating state of heating, ventilation, and air conditioning (HVAC), a heated cooled seat (HCS), a multi-meter information display (MID), or a head-up display (HUD).

The second vehicle environment may be a setting related to the operation control of the host vehicle. For example, the second vehicle environment may be timing settings for unlocking or locking door locks, distance settings for forward collision warning (FCW), timing settings for road departure reduction (RDM), and alert settings for various driver assistance functions of adaptive cruise control (ACC), lane keep assist system (LKAS), BSI (rear side collision prevention assistance system), and the like. The second vehicle environment may be a setting related to an infotainment device available in the host vehicle.

The in-vehicle device 30 has a user account management function (user management function) and can switch the vehicle environment of the host vehicle for each user account. More specifically, the in-vehicle device 30 manages the setting information of the vehicle environment for each user account and can switch the vehicle environment by executing a process based on the setting information of the user account for the selected user account. For example, the user management function may be implemented with the operating system. In this case, switching the vehicle environment may be implemented as a user account login process. The automatic adjustment function of the seat position may be implemented as a function of the operating system or may be implemented as a function of an application program operating on the operating system.

The vehicle in which the in-vehicle device 30 is mounted is, for example, a vehicle such as a three- or four-wheeled vehicle, and includes a vehicle using an internal combustion engine such as a diesel engine or a gasoline engine as a motive power source, an electric vehicle using an electric motor as a motive power source, a hybrid vehicle having an internal combustion engine and an electric motor, or the like. The above-described electric vehicle is driven using electric power with which a battery such as, for example, a secondary battery, a hydrogen fuel cell, a metal fuel cell, or an alcohol fuel cell, is discharged.

The in-vehicle device 30 includes, for example, an engine switch 32, a power supply unit 34, an information outputter 36, a door lock controller 38, a door sensor 40, a seat controller 42, an out-of-cabin communication unit 50, an in-cabin communication unit 60, a controller 70, an engine ECU 82, and an in-vehicle storage 90.

The engine switch 32 is, for example, a switch provided at a position where a manipulation can be performed by a user of the host vehicle. The engine switch 32 is, for example, a mechanical switch. When the engine switch 32 is manipulated by the user, a manipulation signal indicating that a manipulation has been performed is output to the controller 70. The engine switch 32 is an example of a “detector.”

The power supply unit 34 is provided, for example, in the vicinity of the engine switch 32. When the engine switch 32 has been manipulated, the power supply unit 34 supplies electric power from the engine switch 32 to a portable wireless terminal 10 located within a predetermined range based on control of the controller 70. For example, the power supply unit 34 and the power receiver 18 of the portable wireless terminal 10 transmit and receive electric power using the principle of electromagnetic induction.

The information outputter 36 outputs predetermined information in accordance with an instruction of the controller 70. The information outputter 36 is a display that displays indicators and information as images. The display is, for example, a display of an instrument panel that displays a state (speed or the like) of the host vehicle. The display may be, for example, a liquid crystal display (LCD), an organic electroluminescence (EL) display device, or the like. The display may be a head-up display that reflects an image on a window of the host vehicle, a display provided in a navigation device, or the like. The information outputter 36 may be a display device in which a display and an inputter are integrally configured, such as a touch panel. The information outputter 36 may be a speaker that outputs a sound.

The door lock controller 38 and the seat controller 42 are implemented by executing a program in a processor such as, for example, a central processing unit (CPU). The door lock controller 38 is connected to a door lock actuator (not shown), the door sensor 40, and the controller 70. For example, when an instruction signal for the locking or unlocking of the door lock of the host vehicle has been received from the controller 70, the door lock controller 38 controls the door lock actuator so that the door lock actuator executes the locking or unlocking of the door lock. The door lock actuator controls the door lock so that the door lock is in an open or closed state by driving a door lock mechanism provided in the host vehicle. The door lock controller 38 may be a part of the controller 70.

The door sensor 40 is, for example, a capacitance change type touch sensor in which the capacitance changes when the user touches a door handle. The door sensor is in an OFF state normally. When the user touches the door handle and the capacitance changes to a predetermined value or more, the door sensor 40 outputs an instruction signal for unlocking the door lock in an ON state to the controller 70 via the door lock controller 38.

The seat controller 42 is connected to the seat drive actuator (not shown) and the controller 70. For example, when an instruction signal for a change in the position of the seat in the host vehicle has been received from the controller 70, the seat controller 42 controls the seat drive actuator so that the seat drive actuator moves the seat back and forth. A control target of the seat controller 42 is typically a driver's seat and/or a passenger seat, but other seats may also be controlled if other seats can be electrically controlled. The seat drive actuator moves the seat to a designated position by driving a sliding mechanism provided in the host vehicle to move the seat back and forth. When the seat is an electrically controllable reclining seat, the seat controller 42 may be configured to control a tilt of the seat in addition to the seat position. The seat controller 42 may be a part of the controller 70.

The out-of-cabin communication unit 50 includes an out-of-cabin antenna 52 and an out-of-cabin communicator 54 electrically connected to the out-of-cabin antenna 52. The out-of-cabin antenna 52 is provided, for example, on a door mirror on the driver's seat side of the host vehicle, the door handle, or the like. The out-of-cabin communicator 54 is provided, for example, below the surface of an instrument panel. In accordance with the reception of an instruction signal for unlocking the door lock or an instruction signal for locking the door lock from the controller 70, the out-of-cabin communication unit 50 transmits an out-of-cabin request signal for requesting the transmission of a user ID to the portable wireless terminal 10 outside of the cabin. The out-of-cabin antenna 52 receives an out-of-cabin response signal transmitted from the portable wireless terminal 10. The out-of-cabin communicator 54 acquires an out-of-cabin response signal received by the out-of-cabin antenna 52, performs amplification, decoding, or other processing on the acquired out-of-cabin response signal, and outputs information included in the out-of-cabin response signal to the controller 70.

The in-cabin communication unit 60 is provided, for example, under the surface of the instrument panel. The in-cabin communication unit 60 includes an in-cabin antenna 62 and an in-cabin communicator 64 electrically connected to the in-cabin antenna 62. The in-cabin antenna 62 transmits an in-cabin request signal to the portable wireless terminal 10 in the cabin. The in-cabin antenna 62 receives an in-cabin response signal from the portable wireless terminal 10 in the cabin. The in-cabin communicator 64 acquires the in-cabin response signal received by the in-cabin antenna 62, performs amplification, decoding, or other processing on the acquired in-cabin signal, and outputs information included in the in-cabin response signal to the controller 70.

The controller 70 includes, for example, a power supply controller 72, a communication controller 74, a use permitter 76, and a user manager 78. The power supply controller 72, the communication controller 74, the use permitter 76, and the user manager 78 are implemented by a hardware processor such as a CPU executing the program (software). The program may be implemented, for example, as a vehicle operating system having a control function of the host vehicle, or may be implemented as an application program operating on the vehicle operating system. Also, some or all of these components may be implemented by hardware (including a circuit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The in-vehicle storage 90 is implemented by, for example, a non-volatile storage device such as a read-only memory (ROM), an electrically erasable and programmable read-only memory (EEPROM), or a hard disk drive (HDD) and a volatile storage device such as a random-access memory (RAM) or a register.

The power supply controller 72 controls the power supply unit 34 so that the power supply unit 34 supplies electric power to the portable wireless terminal 10 and enables the portable wireless terminal 10 to transmit the user ID to the host vehicle using the supplied electric power.

The communication controller 74 controls the out-of-cabin communication unit 50 or the in-cabin communication unit 60 so that the out-of-cabin communication unit 50 or the in-cabin communication unit 60 communicates with the portable wireless terminal 10. When the power supply unit 34 supplies electric power to the portable wireless terminal 10 according to electromagnetic induction, in a case where the use permitter 76 permits the start of the host vehicle, the communication controller 74 causes the in-cabin communication unit 60 to transmit an in-cabin request signal to the cabin and detects an in-cabin response signal, which is a response of the portable wireless terminal 10 to the transmitted in-cabin request signal.

The use permitter 76 decides to permit or disallow the use of the host vehicle by the user. Permitting the use of the host vehicle here is, for example, permitting the unlocking of the door lock of the host vehicle, permitting the start of the host vehicle, or the like. For example, the use permitter 76 compares the user ID received from the portable wireless terminal 10 using the out-of-cabin communication unit 50 with the user ID registered in the in-vehicle storage 90 in advance and permits the unlocking of the door lock of the host vehicle based on a comparison result. For example, the use permitter 76 permits the unlocking of the door lock of the vehicle when the received user ID is identical to the user ID registered in the in-vehicle storage 90 in advance. This user ID is included in the out-of-cabin response signal.

For example, the use permitter 76 compares the user ID received from the portable wireless terminal 10 using the in-cabin communication unit 60 with the user ID registered in the in-vehicle storage 90 in advance and permits the start of the vehicle based on a comparison result. The use permitter 76 permits the start of the vehicle when the received user ID is identical to the user ID registered in the in-vehicle storage 90 in advance. This user ID is included in the in-cabin response signal. The in-cabin response signal includes information indicating the remaining amount of electric power of the power supply 20. Permitting the start of the vehicle is permitting control so that the vehicle is in any state such as a state in which the engine is started, a state in which a motor is started, or a state in which a lock of a steering wheel is unlocked.

The user manager 78 manages a user account registered in the in-vehicle device for the user of the host vehicle. Setting information for automatic adjustment of the seat position (hereinafter referred to as “seat position setting information”) is associated with the user account. The user account does not necessarily have to correspond one-to-one with the user. For example, the user may create a plurality of user accounts with different setting content for the seat position setting information and separately use the user accounts in accordance with a use state, a purpose, and the like. For simplicity below, it is assumed that one user account is registered for each user in the in-vehicle device 30. User account management information (hereinafter referred to as “account management information”), for example, is stored in the in-vehicle storage 90.

The user manager 78 automatically adjusts the seat position in accordance with a user account (hereinafter referred to as a “target account”) designated as a setting target. More specifically, the user manager 78 acquires the seat position setting information of the target user account with reference to the account management information and automatically adjusts the seat position based on the acquired seat position setting information. The target account may be designated when the user performs a manipulation of selecting the user account to be used as the target account from the user accounts registered in the in-vehicle device 30. When the user ID is transmitted from the portable wireless terminal 10, the target account may be mechanically decided on by associating it with the portable wireless terminal 10. The user manager 78 is an example of an “identifier” and a “setter.”

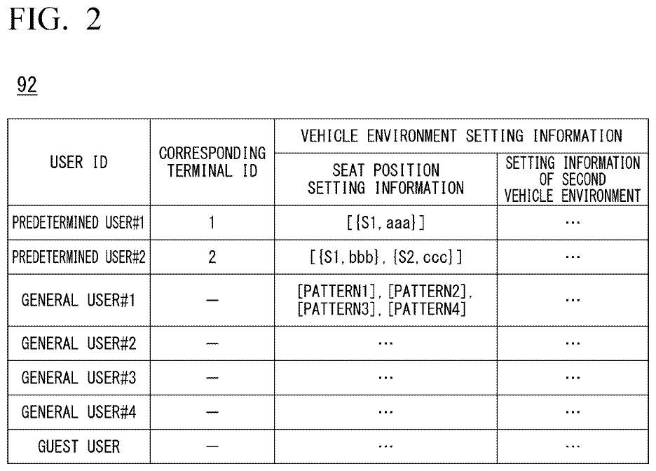

FIG. 2 is a diagram showing a specific example of account management information. The account management information 92 is managed, for example, as a table in which a user ID is associated with a corresponding terminal ID and vehicle environment setting information. The user ID is identification information of the user account. The corresponding terminal ID indicates the association between the user account and the portable wireless terminal 10. In the present embodiment, because two portable wireless terminals 10A and 10B are assumed, the corresponding terminal ID is associated with any of the two user IDs. In the example of FIG. 2, the corresponding terminal ID “1” indicates the portable wireless terminal 10A and the corresponding terminal ID “2” indicates the portable wireless terminal 10B. The example of FIG. 2 indicates a case where the portable wireless terminal 10A (here, corresponding terminal ID “1”) is associated with “predetermined user #1” and the portable wireless terminal 10B (here, corresponding terminal ID “2”) is associated with “predetermined user #2.”

The vehicle environment setting information includes setting information of the seat position as the first vehicle environment and setting information of the second vehicle environment. The seat position setting information is expressed, for example, by a set of identification information of a control target seat and information of a target seat position (for example, an amount of displacement from a reference position). In the example of FIG. 2, the seat position setting information of “predetermined user #1” indicates that a seat identified by “S1” is controlled so that the seat is at the seat position “aaa.” In the example of FIG. 2, the seat position setting information of “predetermined user #2” indicates that a seat identified by “S1” is controlled so that the seat is at a seat position “bbb” and a seat identified by “S2” is controlled so that the seat is at a seat position “ccc.” Thus, the seat position setting information may include setting information for a plurality of seats.

In the example of FIG. 2, the seat position setting information of “general user #1” indicates a case where a plurality of setting patterns (here, patterns 1 to 4) are registered. The above-described seat position setting information of “predetermined user #1” and “predetermined user #2” is all examples of cases where one setting pattern is registered. One of the plurality of setting patterns to be adopted may be decided on by a default value or may be decided on by the user's selection manipulation. A plurality of setting patterns may be changed by the user's switching manipulation or a previously used setting pattern may be automatically handed over.

In the example of FIG. 2, “predetermined user #1” and “predetermined user #2” are predetermined user accounts registered in advance in the in-vehicle device 30 of the initial state and are user accounts associated with the portable wireless terminal 10 of the user. Here, two predetermined user accounts are created in consideration of two portable wireless terminals 10A and 10B. For example, the predetermined user account is registered in the in-vehicle device 30 by a manufacturer of the host vehicle, a manufacturer of the in-vehicle device, a car dealer that sells the host vehicle or the in-vehicle device, or the like. The seat position setting information set in the predetermined user account may be uniformly decided on by a registrant (for example, a manufacturer or a car dealer) or may be decided on by the registrant to reflect the user's request.

### [4. Process at Time of Boarding and Starting]

[4.1. Process at Time of Boarding; when Door Lock is Unlocked Through Communication]

When the user boards the host vehicle, the following process is performed. For example, when a predetermined condition is satisfied (for example, when the controller 70 acquires an instruction signal for unlocking the door lock), the communication controller 74 of the controller 70 causes the out-of-cabin communication unit 50 to transmit an out-of-cabin request signal.

When the out-of-cabin request signal is received, the portable wireless terminal transmits an out-of-cabin response signal, which is a response to the out-of-cabin request signal, to the out-of-cabin communication unit 50.

The user manager 78 of the controller 70 determines whether or not the user ID included in the out-of-cabin response signal received by the out-of-cabin communication unit 50 is identical to the user ID stored in the in-vehicle storage 90. When the user IDs are identical, the user manager 78 causes the door lock controller 38 to unlock the door lock of the host vehicle. Thereby, the user can board the host vehicle.

### [4.2. Process at Time of Starting; Process at Normal Time]

For example, as described above, when the door lock is unlocked through communication and an engine start manipulation is performed, the communication controller 74 causes the in-cabin communication unit 60 to transmit an in-cabin request signal. The engine start manipulation is, for example, a manipulation in which the engine switch 32 is pressed in a state in which a brake pedal is depressed. When the portable wireless terminal 10 receives an in-cabin request signal, the portable wireless terminal 10 transmits an in-cabin response signal, which is a response to the in-cabin request signal, to the in-cabin communication unit 60.

The user manager 78 of the controller 70 determines whether or not a user ID included in the in-cabin response signal received by the in-cabin communication unit 60 is identical to the user ID stored in the in-vehicle storage 90. When the user IDs are identical, the user manager 78 causes the engine ECU 82 to operate the engine. Thereby, the user can start the engine of the host vehicle.

### [5. Automatic Adjustment Function for Vehicle Environment]

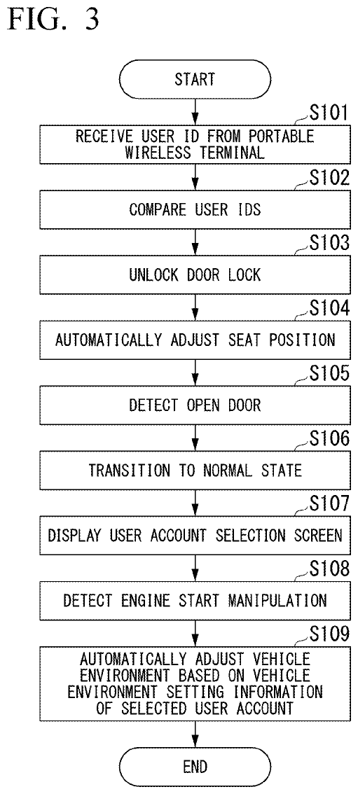

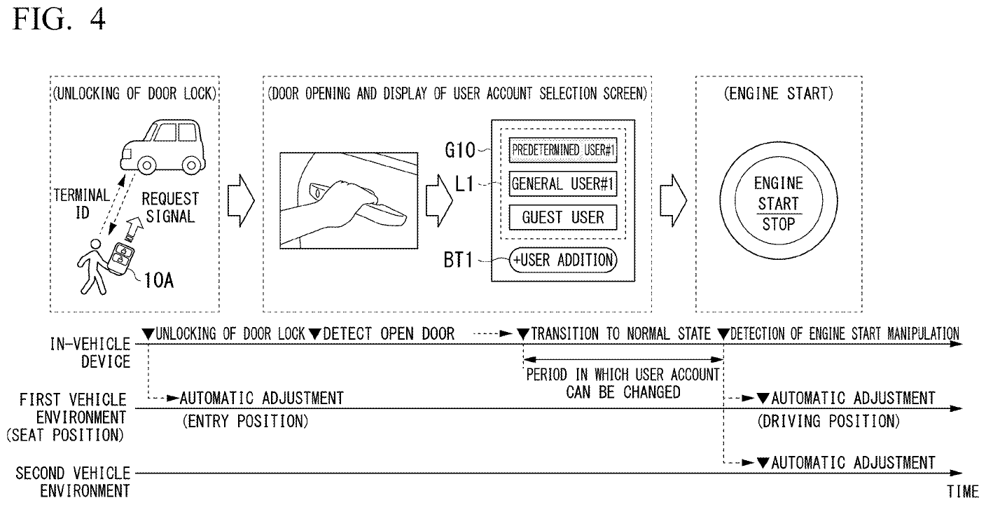

FIG. 3 is a flowchart showing an example of a flow of a process executed by the in-vehicle device 30 with respect to automatic adjustment of the vehicle environment. FIG. 4 is a diagram schematically showing a situation in which the flowchart of FIG. 3 is executed. Hereinafter, the flow of the flowchart of FIG. 3 will be described with reference to FIG. 4 as appropriate.

### (Unlocking of Door Lock)

First, at the start of the flowchart, the user is approaching the host vehicle while holding the portable wireless terminal 10A to start the use of the host vehicle. In this situation, the in-vehicle device 30 receives a user ID from the portable wireless terminal 10A by detecting the portable wireless terminal 10A and transmitting a request signal (S101). Subsequently, the in-vehicle device 30 compares the received user ID with the user ID registered in the in-vehicle storage 90 in advance (S102) and unlocks the door lock of the host vehicle when the two user IDs are identical. The in-vehicle device 30 automatically adjusts the seat position in accordance with the unlocking of the door lock (S104). More specifically, the in-vehicle device 30 acquires seat position setting information associated with the portable wireless terminal 10A and automatically adjusts the seat position. Here, for example, the seat is moved to a registered entry position.

### (Door Opening and User Account Selection Screen Display)

Subsequently, the user performs a manipulation of opening the door with respect to the host vehicle whose door lock is unlocked. When this manipulation is detected by the door sensor 40 (S105), the in-vehicle device 30 transitions from a power-saving state to a normal state (S106). When the in-vehicle device 30 transitions to a startup state, a screen for prompting the user to select a user account is displayed (S107) and a user account selection manipulation can be received. For example, the in-vehicle device 30 displays a user account selection screen G10 as exemplified in FIG. 4 in the startup state. The user account selection screen G10 displays “predetermined user #1,” “general user #1,” and “guest user” as a list of selectable user accounts L1 and displays a button interface BT1 for receiving a new user addition manipulation. The time required for the in-vehicle device 30 to return from the power-saving state to the normal state is a short time (about several seconds) and the timing of the open-door detection and the timing of the return to the normal state of the in-vehicle device 30 can be regarded as substantially the same timing. The user manager 78 may be configured to include a sound outputter for prompting the user to perform a user account selection manipulation by voice when a user account selection screen is displayed.

The in-vehicle device 30 displays the user account selection screen G10 in a state in which a user account (hereinafter referred to as “previously selected user”) selected at the time of the previous use of the host vehicle in the initial state after startup is selected. The example of FIG. 4 indicates a case where the previously selected user is “predetermined user #1.” To perform such a display operation, the user manager 78 of the in-vehicle device 30 is assumed to store information of the previously selected user in the in-vehicle storage 90. In this state, the user can select another user account that is not selected in the initial state or can proceed to the next engine start manipulation without selecting another user account. In the latter case, the user account selected in the initial state (previously selected user account) is used.

### (Engine Start)

When it is detected that the engine start manipulation has been performed with one of the user accounts selected (S108), the in-vehicle device 30 automatically adjusts the vehicle environment including the seat position based on the vehicle environment setting information of the selected user account or the vehicle environment setting information of the previously selected user (S109). Here, the state in which any user account is selected includes a state in which the previously selected user is automatically selected in the initial state and a state in which a user account different from the previously selected user is selected. At this time, the in-vehicle device 30 decides on user account vehicle environment setting information to be used for automatic adjustment according to a situation before the engine start manipulation.

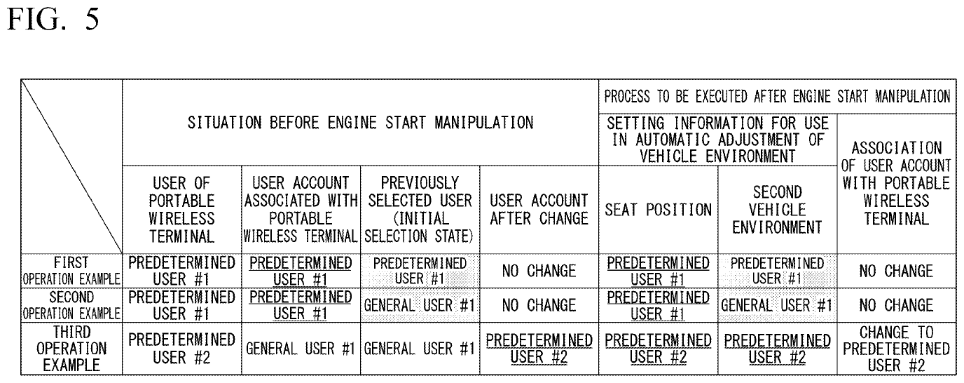

FIG. 5 is a diagram showing an example of an operation of automatic adjustment of the vehicle environment. Here, it is assumed that “predetermined user #1,” “predetermined user #2,” and “general user #1” are registered in the in-vehicle device 30 and the user uses the host vehicle using the portable wireless terminal 10A. First, the first operation example is an example of an operation of a case where the user of the portable wireless terminal 10A is a user of “predetermined user #1,” the user account associated with the portable wireless terminal 10A is “predetermined user #1,” the user account selected at the time of previous use (previously selected user) is “predetermined user #1,” and the user performs the engine start manipulation without making a change from the user account of the initial state. In this case, the in-vehicle device 30 automatically adjusts the seat position and the second vehicle environment based on the vehicle environment setting information of “predetermined user #1” selected in the initial state. In this case, the user can adjust the vehicle environment of the host vehicle with the content set for himself or herself without performing a user account selection manipulation (change manipulation). In this case, because the user account is not changed from the initial selection state, the in-vehicle device 30 does not change the association between the portable wireless terminal 10A and the user account.

Subsequently, the second operation example is an example of an operation of a case where the user of the portable wireless terminal 10A is a user of “predetermined user #1,” the user account associated with the portable wireless terminal 10A is “predetermined user #1,” a previously selected user is “general user #1,” and the user performs the engine start manipulation without making a change from the user account of the initial state. In this case, the in-vehicle device 30 automatically adjusts the seat position based on the vehicle environment setting information of “predetermined user #1” selected in the initial state. On the other hand, for the second vehicle environment, the in-vehicle device 30 performs automatic adjustment based on the vehicle environment setting information of “general user #1,” which is the previously selected user. In this case, even if the user does not perform a manipulation to change the user account before the engine start manipulation, the user can at least adjust the seat position with the content set for himself/herself. In this case, because the user account is not changed from the initial selection state, the in-vehicle device 30 does not change the association between the portable wireless terminal 10A and the user account. In this case, because the user account of the user at the present time will be the previously selected user at the next use, the user at the present time can adjust both the first vehicle environment (seat position) and the second vehicle environment for the host vehicle with content set for himself/herself without performing the manipulation of changing the user account at the next use.

Subsequently, the third operation example is an example of an operation of a case where the user of the portable wireless terminal 10A is a user of “predetermined user #2,” the user account associated with the portable wireless terminal 10A is “general user #1,” a previously selected user is “general user #1,” and the user performs an engine start manipulation after making a change from the user account of the initial state to “predetermined user #2.” In this case, the in-vehicle device 30 automatically adjusts the seat position and the second vehicle environment based on the vehicle environment setting information of “predetermined user #2” after the change. In this case, because the user account is changed from the initial selection state, the in-vehicle device 30 changes the association of the user account with the portable wireless terminal 10A from “general user #1” to “predetermined user #2.” In this case, the portable wireless terminal 10A acquires the user information (the user ID and the vehicle environment setting information) after the change from the in-vehicle device 30 and overwrites the stored user information before the change with the user information after the change. Thus, when the association of the user of the portable wireless terminal 10A, the portable wireless terminal 10A, and the user account is not consistent, the in-vehicle device 30 automatically adjusts the vehicle environment with the vehicle environment setting information of the user account after the change and updates the association of the portable wireless terminal 10A and the user account. In this case, because the user account of the user at the present time will be the previously selected user at the next use, the user at the present time can adjust both the first vehicle environment (seat position) and the second vehicle environment for the host vehicle with content set for himself/herself without performing the manipulation of changing the user account at the next use.

According to the vehicle control system 1 of the above-described embodiment, in relation to the vehicle control system 1 that automatically adjusts the vehicle environment in conjunction with the in-vehicle device having a user management function, the in-vehicle device and the electronic key can be more appropriately linked to improve the convenience of the vehicle.

As described above, the in-vehicle device 30 of the embodiment has a user management function and can manage automatic adjustment of the vehicle environment for each user account. However, in vehicles equipped with conventional in-vehicle devices that do not have such functions, the automatic adjustment of the vehicle environment has been managed by associating it with a portable wireless terminal, but there are not a few who prefer the conventional manipulation feeling and manipulability for automatic adjustment of the vehicle environment among the users of such conventional vehicles. On the other hand, as information equipment is becoming more sophisticated, it is assumed that in-vehicle devices can generally have a user management function like the in-vehicle device 30 of the embodiment and manage various types of settings related to the vehicle for each user account in the future. According to the in-vehicle device 30 of the embodiment, the advancement of the in-vehicle device can be implemented and the automatic adjustment of the vehicle environment can implement the manipulation feeling and manipulability similar to those in the conventional method.

Although a case where a user account change manipulation is received during a period until the engine start manipulation is performed from the detection of an open door (an example of a specific action) has been described in the above-described embodiment, a start timing of this period may be a timing when the door lock is unlocked instead of the timing when the open door is detected or may be a timing when the approach of the user is detected (for example, a timing when a request signal is transmitted).

Although the case where the permission to use the host vehicle in the use permitter 76 is executed independently of the user management function has been described in the above-described embodiment, the use permitter 76 may be configured to permit the use of the host vehicle in cooperation with the user management function. For example, a user ID registered in the in-vehicle storage 90 may be managed according to the account management information 92. In this case, the use permitter 76 may be configured to recognize a target account and a corresponding user ID by performing a comparison process with the user ID with reference to the account management information 92. In this case, the use permitter 76 may be configured to perform an automatic adjustment process for the vehicle environment following the permission to use the host vehicle.

The user manager 78 of the in-vehicle device 30 may perform a login process for the user account. For example, the user manager 78 may be configured to manage a password for each user ID and transition to a login state when a user ID and a password input by the user are identical to those managed in the in-vehicle device 30. In this case, the automatic adjustment of the vehicle environment may be performed as a part of the process of transitioning to the login state.

The user manager 78 may be configured to switch a setting pattern of the seat position setting information in accordance with a manipulation on an input device such as a switch or a button. For example, such an input device may be implemented as a door switch. For example, a number of door switches corresponding to each setting pattern may be provided and a setting pattern associated with the manipulated door switch may be selected. The user manager 78 may automatically adjust the vehicle environment in accordance with this selection. The user manager 78 may be configured to provide one door switch instead of providing a plurality of door switches, switch the setting pattern every time there is a manipulation, or recognize a setting pattern to be selected in a manipulation mode (for example, the number of button manipulations, a button press length, or the like).

Although modes for carrying out the present invention have been described above using embodiments, the present invention is not limited to the embodiments and various modifications and substitutions can also be made without departing from the scope and spirit of the present invention.

What is claimed is:

1. A mobile object setting system including a setting device configured to perform a process of setting equipment provided in a mobile object and a plurality of terminal devices capable of communicating with the setting device,
wherein the setting device includes a storage device configured to store a program and setting information of the equipment and a hardware processor,
wherein the hardware processor
manages the setting information in association with a user of the mobile object by executing the program stored in the storage device,
identifies the user of the mobile object,
detects a specific action to be performed when the user of the mobile object boards the mobile object, and
acquires setting information of the equipment associated with the identified user from the storage device to set the equipment based on the acquired setting information, and
wherein the hardware processor receives a selection manipulation of the user until a predetermined manipulation is performed after the specific action is detected.

2. The mobile object setting system according to claim 1, wherein the predetermined manipulation is a manipulation of starting up the mobile object.

3. The mobile object setting system according to claim 2, wherein the hardware processor determines the user when the prescribed manipulation has been performed and sets the equipment based on setting information associated with the determined user.

4. The mobile object setting system according to claim 1, wherein the hardware processor identifies the user of the mobile object based on user information received from a terminal device of the user and overwrites the user information of the user before a change stored in the terminal device with the user information of the user after the change when the selection manipulation of the user has been received.

5. The mobile object setting system according to claim 1, wherein the hardware processor sets a position of a seat of the mobile object based on setting information of the user until the predetermined manipulation is performed after the specific action is detected and sets the equipment other than the seat after the predetermined manipulation is performed.

6. The mobile object setting system according to claim 1, wherein the hardware processor sets a position of a seat of the mobile object based on setting information received from the terminal device when the selection manipulation of the user has not been performed.

7. The mobile object setting system according to claim 6,
wherein the storage device stores setting information of a previous user of the mobile object, and
wherein the hardware processor sets the equipment other than the seat based on the setting information of the previous user when the selection manipulation of the user has not been performed.

8. The mobile object setting system according to claim 1, wherein the hardware processor identifies a user of the mobile object using a display device including a display configured to display a list of users registered in the setting device and an inputter configured to receive a manipulation of selecting a user among the users displayed on the display.

9. The mobile object setting system according to claim 1, wherein the display device includes a sound output device configured to output a sound for prompting the user to perform the selection manipulation.

10. A mobile object setting system including a setting device configured to perform a process of setting equipment provided in a mobile object and a plurality of terminal devices capable of communicating with the setting device,
wherein the setting device includes a storage device configured to store a program and setting information of the equipment and a hardware processor,
wherein the hardware processor
manages the setting information in association with a user of the mobile object by executing the program stored in the storage device,
identifies the user of the mobile object,
detects a specific action to be performed when the user of the mobile object boards the mobile object, and
acquires setting information of the equipment associated with the identified user from the storage device to set the equipment based on the acquired setting information, and
wherein the terminal device stores setting information corresponding to any one of users of the mobile object and overwrites the setting information stored in advance with setting information of the identified user when the hardware processor identifies the user of the mobile object.

11. A mobile object setting method for use in a mobile object setting system including a setting device configured to perform a process of setting equipment provided in a mobile object and a plurality of terminal devices capable of communicating with the setting device, the mobile object setting method comprising:
managing, by the setting device, the setting information of the equipment in association with a user of the mobile object;
identifying, by the setting device, the user of the mobile object;
detecting, by the setting device, a specific action to be performed when the user of the mobile object boards the mobile object;
acquiring, by the setting device, setting information of the equipment associated with the identified user to set the equipment based on the acquired setting information; and
receiving, by the setting device, a selection manipulation of the user until a predetermined manipulation is performed after the specific action is detected.

12. A mobile object setting method for use in a mobile object setting system including a setting device configured to perform a process of setting equipment provided in a mobile object and a plurality of terminal devices capable of communicating with the setting device, the mobile object setting method comprising:
managing, by the setting device, the setting information of the equipment in association with a user of the mobile object;
identifying, by the setting device, the user of the mobile object;
detecting, by the setting device, a specific action to be performed when the user of the mobile object boards the mobile object;
acquiring, by the setting device, setting information of the equipment associated with the identified user to set the equipment based on the acquired setting information; and
storing, by the terminal device, setting information corresponding to any one of users of the mobile object and overwriting the setting information stored in advance with setting information of the identified user when the hardware processor identifies the user of the mobile object.
